(19) United States
(12) Patent Application Publication
(10) Pub. No.: US 2022/0036713 A1
(43) Pub. Date: Feb. 3, 2022

(54) METHOD AND SYSTEM FOR OPTIMIZING ACCESS RESTRICTIONS TO SHARED RESOURCES

(71) Applicant: Johnson Controls Tyco IP Holdings LLP, Milwaukee, WI (US)

(72) Inventors: Ronan Fineen Hennessy, Carrigaline (IE); Róisín Ann O'Brien, Glanmire (IE); Eamonn Jerry O'Toole, Ballincollig (IE); Rachel D.M. Ellerman, Shorewood, WI (US)

(73) Assignee: Johnson Controls Tyco IP Holdings LLP, Milwaukee, WI (US)

(21) Appl. No.: 17/386,983

(22) Filed: Jul. 28, 2021

Related U.S. Application Data
(60) Provisional application No. 63/058,173, filed on Jul. 29, 2020.

(51) Int. Cl. G08B 21/02; G06Q 10/06; G06Q 10/10; G07C 9/29

(52) U.S. Cl. CPC G08B 21/02; G07C 9/29; G06Q 10/1095; G06Q 10/06311

(57) ABSTRACT

A method includes receiving, by one or more processing circuits, risk data indicative of at least one of behavior of the users relating to the shared space or a user risk relating to a risk of one or more of the users contracting or spreading a disease, determining, by the one or more processing circuits, an accessibility limit for the shared space based on the risk data, the accessibility limit comprising at least one of an occupancy limit for the shared space or a timeframe during which the shared space is prohibited from occupancy, and generating, by the one or more processing circuits, an indicator of the accessibility limit for the shared space, the indicator providing an indication to the users of at least one of the occupancy limit or the timeframe during which the shared space is prohibited from occupancy.

### CROSS-REFERENCE TO RELATED PATENT APPLICATION

This application claims the benefit of and priority to U.S. Provisional Patent Application No. 63/058,173 filed Jul. 29, 2020, the entirety of which is incorporated by reference herein.

### BACKGROUND

The present disclosure relates generally to building management and access control systems for shared resources.

Modern workplaces feature multiple shared resources. In this disclosure, the term “shared resource” relates both to equipment and spaces that may be used by multiple different people at different times. Examples of shared equipment include multi-function printers (MFPs) in an office or centrifuge machines in a laboratory. Examples of shared spaces include rest rooms, conference rooms, dining areas, elevators, and corridors. Shared equipment may be located within shared spaces, such as shared MFPs within a shared print room. Some of these resources are shared informally, with no fixed schedule or booking system. However, there are occasions where it may be desirable for access to the shared resource to be restricted for a limited period of time, such as for maintenance or cleaning.

### SUMMARY

One implementation of the present disclosure is a method of mitigating risk of infection for users of a shared space of a building, the method including receiving, by one or more processing circuits, risk data indicative of at least one of behavior of the users relating to the shared space or a user risk relating to a risk of one or more of the users contracting or spreading a disease. The method includes determining, by the one or more processing circuits, an accessibility limit for the shared space based on the risk data, the accessibility limit including at least one of an occupancy limit for the shared space or a timeframe during which the shared space is prohibited from occupancy and generating, by the one or more processing circuits, an indicator of the accessibility limit for the shared space, the indicator providing an indication to the users of at least one of the occupancy limit or the timeframe during which the shared space is prohibited from occupancy.

In some embodiments, the timeframe is a time of day, and wherein determining the accessibility limit includes at least one of limiting access to the shared space to at least a portion of users during the time of day or diverting at least a portion of users to an alternative shared space during the time of day.

In some embodiments, the indicator is at least one of a visible indicator providing a visual indication of the accessibility limit or an audible indicator providing an audible indication of the accessibility limit.

In some embodiments, the method further includes automatically initiating, by the one or more processing circuits, a disinfection device for the space responsive to determining the accessibility limit.

In some embodiments, the disinfection device includes a disinfecting light system.

In some embodiments, the method includes generating, by the one or more processing circuits, social distancing scores for the users of the shared space and determining, by the one or more processing circuits, the accessibility limit for the shared space includes determining the accessibility limit using the social distancing scores.

In some embodiments, the method includes transmitting, by the one or more processing circuits responsive to determining the accessibility limit for the shared space, at least one of control signals or data to an access control device configured to cause the access control device to control access to the shared space.

In some embodiments, the at least one of control signals or data are configured to cause the access control device to actuate a physical constraint to accessing the space.

In some embodiments, the at least one of control signals or data are configured to cause the access control device to determine permissions for one or more of the users to access the space.

In some embodiments, the method includes scheduling cleaning of the shared space based on the accessibility limit.

In some embodiments, the shared space is a conference room. In some embodiments, the accessibility limit includes at least one of prohibiting access to the conference room, limiting access to the conference room during one or more time periods, or limiting booking of the conference room within a booking system.

In some embodiments, the method includes receiving, by the one or more processing circuits, a heat map of the shared space, wherein determining the accessibility limit for the shared space includes determining the accessibility limit using the heat map.

In some embodiments, the method includes determining, by the one or more processing circuits, an alternative shared space, determining, by the one or more processing circuits, possible routes to the alternative shared space, receiving, by the one or more processing circuits, a heat map relating to the possible routes, determining, by the one or more processing circuits, using the heat map, risks relating to contact with other users for the possible routes, selecting, by the one or more processing circuits, a first route from among the possible routes based on the risks, and providing, by the one or more processing circuits, directions to the alternative shared space using the first route.

In some embodiments, the method includes providing directions to the alternative shared space.

In some embodiments, the method includes identifying an alternative conference room.

In some embodiments, the method includes transmitting, by the one or more processing circuits, the indicator to a user device, the indicator including data configured to cause the user device to provide an indication of the accessibility limit for the shared space.

In some embodiments, the method includes providing the indicator via a digital sign proximate to an entrance to the shared space.

In some embodiments, the shared space is a bathroom. In some embodiments, the digital sign is provided proximate to a door to the bathroom. In some embodiments, the indicator indicates the bathroom is closed.

In some embodiments, the method includes providing, by the one or more processing circuits responsive to determining the accessibility limit to the shared space, an indication of an alternative shared space to use instead of the shared space.

In some embodiments, the method includes providing, by the one or more processing circuits, directions to the alternative shared space by determining potential routes to the alternative shared space, determining risks relating to contact with other users for the potential routes, selecting a first route from among the potential routes based on the risks, and providing directions to the alternative shared space using the first route.

In some embodiments, the method includes receiving, by the one or more processing circuits, historical occupancy data indicating occupancy of the shared space at one or more previous times and determining, by the one or more processing circuits, the accessibility limit for the shared space by determining the accessibility limit using the historical occupancy data.

In some embodiments, the method includes determining, by the one or more processing circuits, the accessibility limit using the historical occupancy data by determining, using the historical occupancy data, a timeframe during which occupancy has been above a threshold level and determining the accessibility limit for the shared space during the timeframe.

In some embodiments, the method further includes receiving, by the one or more processing circuits, current occupancy data for the shared space, wherein determining the accessibility limit for the shared space includes determining the accessibility limit using both the historical occupancy data and the current occupancy data.

Another implementation of the present disclosure is a building system of a building including one or more memory devices storing instructions thereon that, when executed by one or more processors, cause the one or more processors to receive risk data indicative of at least one of behavior of users relating to a shared space or a user risk relating to a risk of one or more of the users contracting or spreading a disease, determine an accessibility limit for the shared space based on the risk data, the accessibility limit including at least one of an occupancy limit for the shared space or a timeframe during which the shared space is prohibited from occupancy, and generate an indicator of the accessibility limit for the shared space, the indicator providing an indication to the users of at least one of the occupancy limit or the timeframe during which the shared space is prohibited from occupancy.

In some embodiments, the instructions cause the one or more processors to generate social distancing scores for the users of the shared space, wherein determining the accessibility limit for the shared space includes determining the accessibility limit using the social distancing scores.

In some embodiments, the instructions cause the one or more processors to transmit, responsive to determining the accessibility limit for the shared space, at least one of control signals or data to an access control device configured to cause the access control device to control access to the shared space.

In some embodiments, the instructions cause the one or more processors to schedule cleaning of the shared space based on the accessibility limit.

Another implementation of the present disclosure is a method of improving efficiency of scheduled maintenance or cleaning activities, the method including identifying, by one or more processing circuits, a worker who will perform a maintenance or cleaning activity. The method including associating, by the one or more processing circuits, a shared resource with the maintenance or cleaning activity and identifying, by the one or more processing circuits, a time at which the maintenance or cleaning activity will start. The method includes performing, by the one or more processing circuits, at least one of providing a notification to one or more users in advance of the time at which the maintenance or cleaning activity will start and that the shared resource will become unavailable or prohibiting use of the shared resource in advance of the time.

In some embodiments, identifying, by the one or more processing circuits, the time at which the maintenance or cleaning activity will start includes determining a distance between the worker and the shared resource, determining rate of progress of the worker towards the shared resource, and calculating an estimated time when the worker will arrive at said shared resource.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a perspective view schematic drawing of a building with a security system, according to some embodiments.

FIG. 2 is a block diagram of building security systems for multiple buildings communicating with a cloud based security system, according to some embodiments.

FIG. 3 is a block diagram illustrating several components of an access control system (ACS) that can be implemented in the building security systems of FIG. 2, according to some embodiments.

FIG. 4 shows an isometric view of a shared resource, according to some embodiments.

FIG. 5 shows a block diagram of an access restriction system, according to some embodiments

FIG. 6 shows a sequence of messages displayed on digital signage, according to some embodiments.

FIG. 7 shows a diagram of a cleaning schedule optimization method, according to some embodiments.

### DETAILED DESCRIPTION

Referring generally to the FIGURES, systems and methods are shown for optimizing access restrictions to shared resources, according to various exemplary embodiments. The present disclosure relates more particularly to enforcing restricted access to shared resources to reduce health risks and improve the efficiency of cleaning and maintenance. Some of these restrictions must be strictly enforced for health and safety reasons. Other restrictions are less critical, but periodic, and may cause disruptions and inefficiencies in the workplace.

A resource may be considered as shared if one or more individuals from a group of authorized people can access the resource. An individual's use of a resource may exclude others from accessing the resource, but this exclusive use will end at some point in time, free up the resource for use by others. Shared equipment is considered to be “in use” if an individual is interacting with it. A shared space is considered to be in use if it is occupied.

The systems and methods discussed herein can be implemented in public restrooms in offices, airports, stadiums, shopping malls, and other built environments. However, the methods and systems described are applicable to all shared resources where access must be temporarily restricted, and also where there are loosely scheduled periods of downtime due to maintenance, cleaning, priority use, etc.

One or more individuals that have access to a shared resource may be carriers of a contagious infection, for example, seasonal influenza, chicken-pox, or a novel coronavirus (e.g. 2019-nCoV). The risk of transmission between individuals that use a shared space can increase due to a number of factors, including the number of simultaneous users and the cumulative total number of users between cleanings. For example, if 10 individuals have access to a restroom, one of them is infected, and all 10 are currently in the restroom, then nine people have a 100% chance of exposure to an infected person.

If only two of the 10 individuals are in the rest room and one is not infected, they may have a 1/9 (11%) chance that the other person in the room is infected. Similarly, the second person to use a restroom after it has been cleaned may have an 11% chance that the person before them was infected; assuming that they themselves are not infected. The tenth of the group to use the restroom, if not infected, may have a 100% chance of the infected person having used the restroom before them, and potentially contaminating some surfaces. Restricting the number of simultaneous users and/or the cumulative total number of users between cleanings can reduce the risk of transmission.

Restrooms may require multiple temporary closures throughout a day. A cleaning operative (e.g., a person or machine) may require the restroom to be vacant before they can start cleaning, which can create multiple potential problems. The cleaning operative may arrive at a restroom that is occupied and must then wait for it to be vacated. This is an inefficient use of the cleaning operative's time. The cleaning operative may be required to shout into a restroom to ask if it is vacant. This may create a feeling of time pressure for the restroom occupants to vacate. A person may arrive at the restroom to find it closed for cleaning, and must find another restroom thus inconveniencing the person. A person may arrive at a restroom to find it closed and then go to the next nearest restroom. The cleaning operative may then arrive at the same restroom a few minutes later, because it is the next one on their schedule.

The disclosed access restriction system beneficially provides digital signage and/or instructs an access control system (ACS) to restrict access to the shared resource at the optimal time. For health hazards, the optimal time may be immediately after a predetermined threshold of acceptable risk has been exceeded. For periodic cleanings or maintenance, the optimal time may be before the arrival of the worker, which ensures that they can start working or cleaning immediately upon their arrival.

### Building Security System

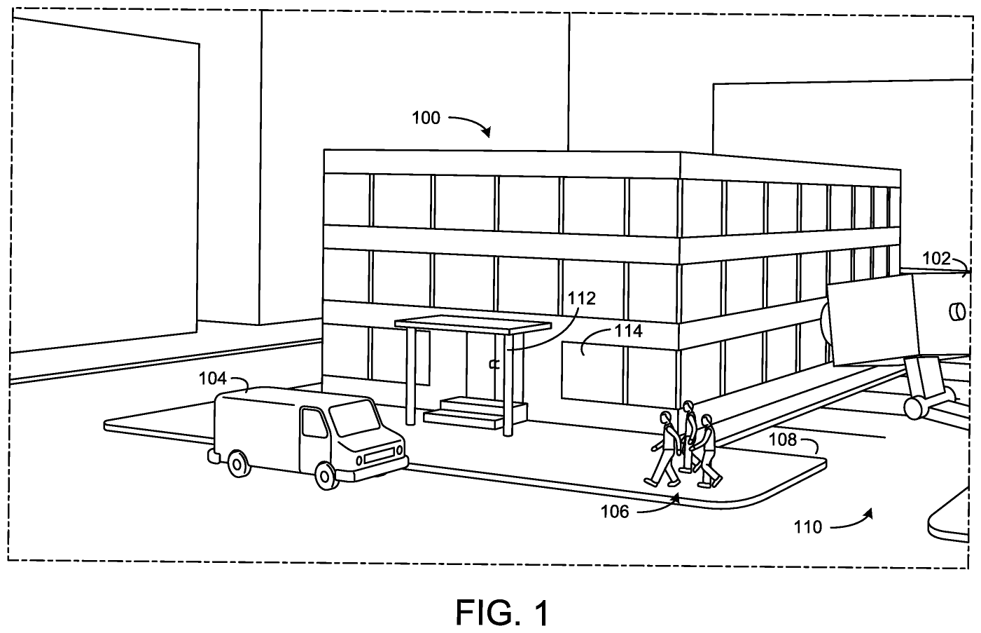

Referring now to FIG. 1, a building 100 with a security camera 102 and a parking lot 110 is shown, according to an exemplary embodiment. The building 100 is a multi-story commercial building surrounded by, or near, the parking lot 110 but can be any type of building in some embodiments. The building 100 may be a school, a hospital, a store, a place of business, a residence, a hotel, an office building, an apartment complex, etc. The building 100 can be associated with the parking lot 110.

Both the building 100 and the parking lot 110 are at least partially in the field of view of the security camera 102. In some embodiments, multiple security cameras 102 may be used to capture the entire building 100 and parking lot 110 not in (or in to create multiple angles of overlapping or the same field of view) the field of view of a single security camera 102. The parking lot 110 can be used by one or more vehicles 104 where the vehicles 104 can be either stationary or moving (e.g. busses, cars, trucks, delivery vehicles). The building 100 and parking lot 110 can be further used by one or more pedestrians 106 who can traverse the parking lot 110 and/or enter and/or exit the building 100. The building 100 may be further surrounded, or partially surrounded, by a sidewalk 108 to facilitate the foot traffic of one or more pedestrians 106, facilitate deliveries, etc. In other embodiments, the building 100 may be one of many buildings belonging to a single industrial park, shopping mall, or commercial park having a common parking lot and security camera 102. In another embodiment, the building 100 may be a residential building or multiple residential buildings that share a common roadway or parking lot.

The building 100 is shown to include a door 112 and multiple windows 114. An access control system can be implemented within the building 100 to secure these potential entrance ways of the building 100. For example, badge readers can be positioned outside the door 112 to restrict access to the building 100. The pedestrians 106 can each be associated with access badges that they can utilize with the access control system to gain access to the building 100 through the door 112. Furthermore, other interior doors within the building 100 can include access readers. In some embodiments, the doors are secured through biometric information, e.g., facial recognition, fingerprint scanners, etc. The access control system can generate events, e.g., an indication that a particular user or particular badge has interacted with the door. Furthermore, if the door 112 is forced open, the access control system, via door sensor, can detect the door forced open (DFO) event.

The windows 114 can be secured by the access control system via burglar alarm sensors. These sensors can be configured to measure vibrations associated with the window 114. If vibration patterns or levels of vibrations are sensed by the sensors of the window 114, a burglar alarm can be generated by the access control system for the window 114.

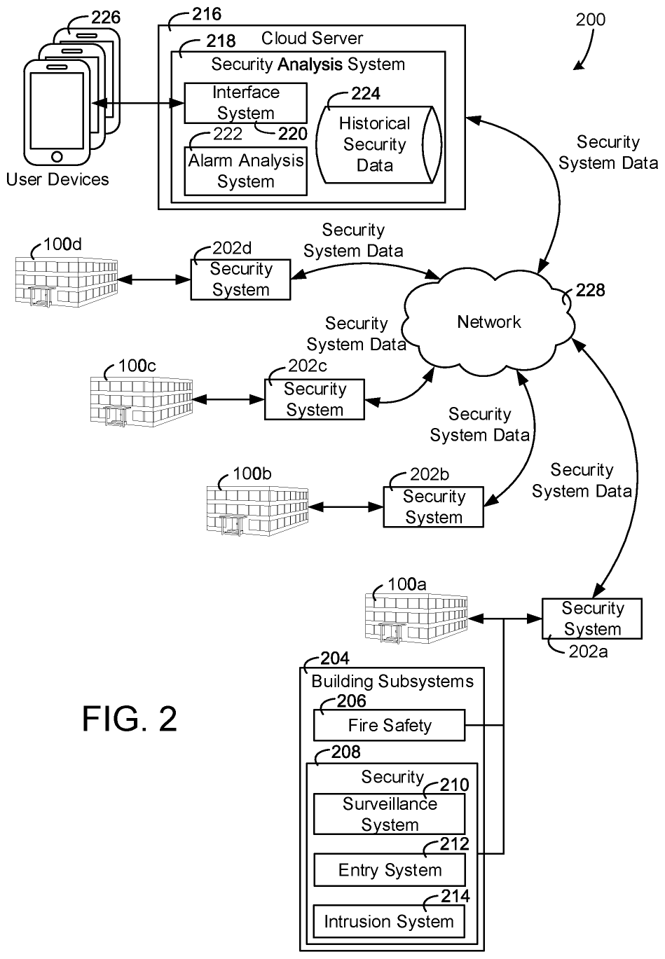

Referring now to FIG. 2, a security system 200 is shown for multiple buildings, according to an exemplary embodiment. The security system 200 is shown to include buildings 100a-100d. Each of buildings 100a-100d is shown to be associated with a security system 202a-202d. The buildings 100a-100d may be the same as and/or similar to building 100 as described with reference to FIG. 1. The security systems 202a-202d may be one or more controllers, servers, and/or computers located in a security panel or part of a central computing system for a building.

The security systems 202a-202d may communicate with, or include, various security sensors and/or actuators, building subsystems 204. For example, fire safety subsystems 206 may include various smoke sensors and alarm devices, carbon monoxide sensors, alarm devices, etc. Security subsystems 208 are shown to include a surveillance system 210, an entry system 212, and an intrusion system 214. The surveillance system 210 may include various video cameras, still image cameras, and image and/or video processing systems for monitoring various rooms, hallways, parking lots, the exterior of a building, the roof of the building, etc. The entry system 212 can include one or more systems configured to allow users to enter and exit the building (e.g., door sensors, turnstiles, gated entries, badge systems, etc.) The intrusion system 214 may include one or more sensors configured to identify whether a window or door has been forced open. The intrusion system 214 can include a keypad module for arming and/or disarming a security system and various motion sensors (e.g., IR, PIR, etc.) configured to detect motion in various zones of the building 100a.

Each of buildings 100a-100d may be located in various cities, states, and/or countries across the world. There may be any number of buildings 100a-100d. The buildings 100a-100d may be owned and operated by one or more entities. For example, a grocery store entity may own and operate buildings 100a-100d in a particular geographic state. The security systems 202a-202d may record data from the building subsystems 204 and communicate collected security system data to the cloud server 216 via network 228.

In some embodiments, the network 228 communicatively couples the devices, systems, and servers of the system 200. In some embodiments, the network 228 is at least one of and/or a combination of a Wi-Fi network, a wired Ethernet network, a ZigBee network, a Bluetooth network, and/or any other wireless network. The network 228 may be a local area network and/or a wide area network (e.g., the Internet, a building WAN, etc.) and may use a variety of communications protocols (e.g., BACnet, IP, LON, etc.). The network 228 may include routers, modems, and/or network switches. The network 228 may be a combination of wired and wireless networks.

The cloud server 216 is shown to include a security analysis system 218 that receives the security system data from the security systems 202a-202d of the buildings 100a-100d. The cloud server 216 may include one or more processing circuits (e.g., memory devices, processors, databases) configured to perform the various functionalities described herein. The cloud server 216 may be a private server. In some embodiments, the cloud server 216 is implemented by a cloud system, examples of which include AMAZON WEB SERVICES® (AWS) and MICROSOFT AZURE®.

A processing circuit of the cloud server 216 can include one or more processors and memory devices. The processor can be a general purpose or specific purpose processor, an application specific integrated circuit (ASIC), one or more field programmable gate arrays (FPGAs), a group of processing components, or other suitable processing components. The processor may be configured to execute computer code and/or instructions stored in a memory or received from other computer readable media (e.g., CDROM, network storage, a remote server, etc.).

The memory can include one or more devices (e.g., memory units, memory devices, storage devices, etc.) for storing data and/or computer code for completing and/or facilitating the various processes described in the present disclosure. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures described in the present disclosure. The memory can be communicably connected to the processor via the processing circuit and can include computer code for executing (e.g., by the processor) one or more processes described herein.

In some embodiments, the cloud server 216 can be located on premises within one of the buildings 100a-100d. For example, a user may wish that their security, fire, or HVAC data remain confidential and have a lower risk of being compromised. In such an instance, the cloud server 216 may be located on-premises instead of within an off-premises cloud platform.

The security analysis system 218 may implement an interface system 220, an alarm analysis system 222, and a database storing historical security data 224, security system data collected from the security systems 202a-202d. The interface system 220 may provide various interfaces of user devices 226 for monitoring and/or controlling the security systems 202a-202d of the buildings 100a-100d. The interfaces may include various maps, alarm information, maintenance ordering systems, etc. The historical security data 224 can be aggregated security alarm and/or event data collected via the network 228 from the buildings 100a-100d. The alarm analysis system 222 can be configured to analyze the aggregated data to identify insights, detect alarms, reduce false alarms, etc. The analysis results of the alarm analysis system 222 can be provided to a user via the interface system 220. In some embodiments, the results of the analysis performed by the alarm analysis system 222 are provided as control actions to the security systems 202a-202d via the network 228.

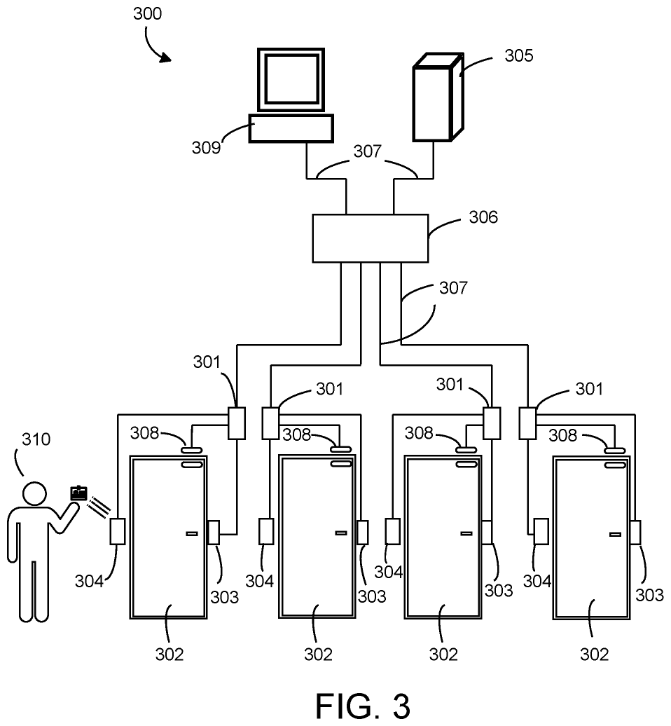

Referring now to FIG. 3, a block diagram of an ACS 300 is shown, according to an exemplary embodiment. The ACS 300 can be implemented in any of the buildings 100a-100d as described with reference to FIG. 2. The ACS 300 is shown to include doors 302. Each of the doors 302 is associated with a door lock 303, an access reader module 304, and one or more door sensors 308. The door locks 303, the access reader modules 304, and the door sensors 308 may be connected to access controllers 301. The access controllers 301 may be connected to a network switch 306 that directs signals, according to the configuration of the ACS 300, through network connections 307 (e.g., physical wires or wireless communications links) interconnecting the access controllers 301 to an ACS server 305 (e.g., the cloud server 216). The ACS server 305 may be connected to an end-user terminal or interface 309 through network switch 306 and the network connections 307.

The ACS 300 can be configured to grant or deny access to a controlled or secured area. For example, a person 310 may approach the access reader module 304 and present credentials, such as an access card. The access reader module 304 may read the access card to identify a card ID or user ID associated with the access card. The card ID or user ID may be sent from the access reader module 304 to the access controller 301, which determines whether to unlock the door lock 303 or open the door 302 based on whether the person 310 associated with the card ID or user ID has permission to access the controlled or secured area.

### Access Restriction System

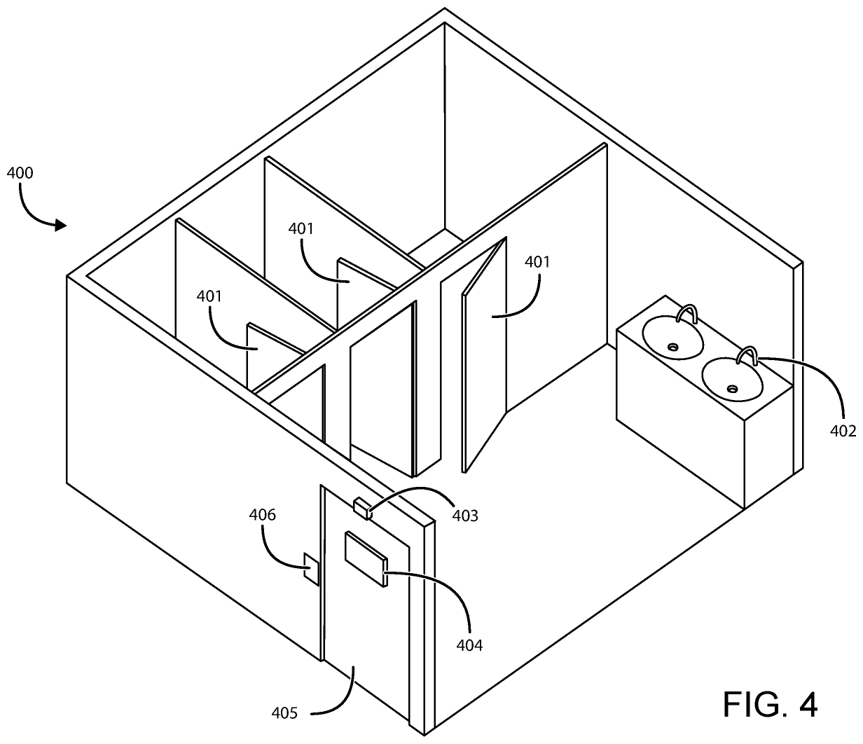

Referring now to FIG. 4, a shared resource is shown, according to some embodiments. The shared resource is a restroom 400, such as may be found in an office building. The door 405 may be secured by a door lock 406 that may be equivalent to door lock 303 of FIG. 3. Use of the door may be monitored by door sensor 403 that may be equivalent to door sensor 308 of FIG. 3. Door sensor 403 may be a magnetic contact sensor, motion sensor, ultrasonic range sensor, or another type of sensor that can detect human presence. An ultrasonic range sensor may be used to determine if a person is walking towards or away from the door, and so infer if they entered or exited the shared space. In some embodiments the door sensor may be placed within the shared space (not shown). In some embodiments the door sensor 403 is placed both outside of the shared space, such as shown in FIG. 4, and also within the shared space. The information from both sensors is combined to determine if people are entering or exiting a space. Door sensor 403 may be used to both count the cumulative number of users of a shared resource and to determine the current occupancy of a shared space by counting entries and exits.

In some embodiments, door sensors may be used to monitor the doors 401 of individual stalls. In some embodiments, motion sensors, or similar types of sensors, may be used to monitor the use of specific regions within a shared space, such as individual stalls in a restroom or tables in a dining room. In some embodiments, sensors may monitor the use of shared equipment, such as fluid flow sensors on faucets 402 or power sensors on MFPs.

In some embodiments, a digital sign 404 may be placed on door 405, adjacent to the door, at the start of a corridor that leads to the door, or in some other location where it will be viewed on approach to the shared resource. Digital sign 404 may be an LCD screen or similar digital display that is connected to a processing unit (not shown). The processing unit may receive instruction through a computer network as to what message should be displayed. In some embodiments, digital sign 404 may comprise of an array of LEDs or other light emitting components that receive instruction to turn on or off in set patterns. The pattern of LEDs may convey meaning, such as spelling out words, or may back-illuminate graphics that convey meaning. In some embodiments, digital sign 404 is a color-changing light, where the color of the light conveys meaning. For example, a traffic light system may be used where red indicates that the shared resource is unavailable, amber indicates that it may become unavailable in the near future, and green indicates that it is available for use. To ensure that the lighting can be interpreted by people with color blindness, the color of the lights may be used as a secondary indicator, with meaning conveyed primarily by the relative locations of the different lights.

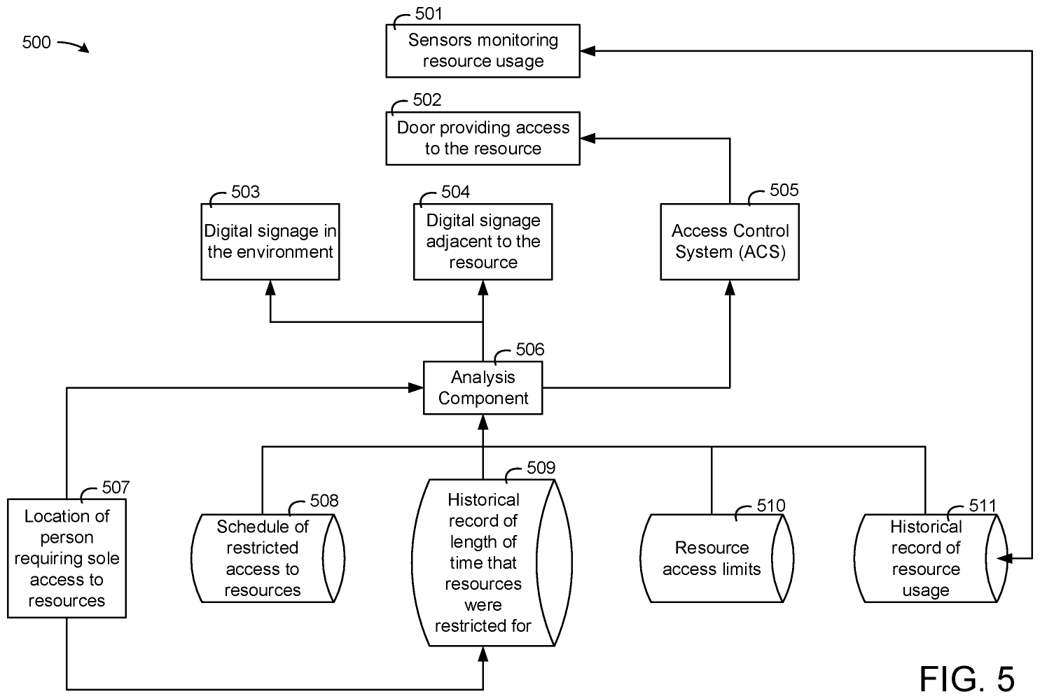

Referring now to FIG. 5, an access restriction system 500 is shown, according to some embodiments. The components of the system 500 can be physical components, sensors, doors, digital signs, access control systems, databases, etc. Furthermore, the components of the system 500 may include one or more processors and one or more memory devices (e.g., an analysis component). The memory devices may store instructions that, when executed by the one or more processors, cause the system 500 to perform some and/or all of the operations related to managing access to a shared resource as described herein. In some embodiments, the access restriction system 500 can be implemented on one or more processing circuits configured to perform some and/or all of the operations related to managing access to a shared resource as described herein

The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.).

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

Analysis component 506 can be configured to determine the optimal time to restrict access to a shared resource. Analysis component 506 may then be configured to command digital signage 504 to display messages that relate to the restricted access. For example, that the resource is unavailable for use, or that it will become unavailable for use within 15 minutes. The analysis component 506 may be configured to command ACS 505, such as described in relation to FIG. 3, which then controls a door lock of the door 502 that provides access to the shared resource.

Digital signage 504 may be configured to include features to improve the accessibility of the information. For example, a user may press on a digital on-screen or physical button to change the screen contrast, magnification, play an equivalent audio message, or trigger some other feature. In some embodiments, physical buttons may feature braille to describe their purpose.

In some embodiments, a person's smart phone or similar personal device may display information equivalent to that presented on digital signage 504. A smart phone may receive information from digital signage 504 (or from the analysis component 506) through direct communication, such as Bluetooth, or analysis component 506 may communicate with a notification system (not shown), which then sends SMS, push notification, email, or other message to the smart phone. A person may be able to configure how their smart phone presents the information, such as by on-screen display, vibration, or audio alert. In some embodiments, the notification is triggered by proximity to digital signage 504. In some embodiments, the notification is triggered by a person's attempt to access a resource to which access has been restricted. This may be used to accommodate visual impairments that would prevent a person from seeing the digital signage. In some embodiments, attempts to access a resource that is restricted triggers an audio warning, such as a verbal statement that the resource is unavailable.

The location of digital signage 504 may be selected to make it viewable by as diverse a group of people as possible. For example, adults and children of different heights and people in wheelchairs. The upper edge of digital signage 504 may be tilted forward away from the wall to increase the range of viewing angles. In some embodiments, at the command of analysis component 506, ACS 505 controls an access barrier or other equipment that prevents or dissuades a person from accessing a shared resource. In some embodiments, analysis component 506 commands a power control system (not shown) to disable power to shared equipment, lighting in a shared space, or other electrical devices in order to prevent their use.

In some embodiments, the system 500 updates digital signage within an environment that is used to direct people to a shared resource. When a shared resource has restricted access, any digital signage that would typically direct people to that resource updates to direct people to an alternative resource instead. For example, when a restroom is closed for cleaning in an airport, the signs that would typically direct people to that restroom would update to direct users to an alternative restroom.

Analysis component 506 may be configured to access stored limits 510 that define access limits for each shared resource. These access limits may define the maximum number of concurrent users, the maximum number of users between cleanings, the maximum number of users within a defined period of time, the maximum cumulative length of time for which users can use the shared resource, some other metric, or a parameter calculated from a combination of these metrics. For example, an access limit may be set as a maximum of 10 people within a shared space at any one time, a maximum of 20 users between cleanings, a maximum of 15 users within a 30 minute period, or a cumulative occupancy of 45 minutes. Cumulative occupancy may count any minute where the shared resource is in use or may count person-minutes. For example, two people jointly occupying a shared space for 10 minutes would be calculated as 20 person-minutes. Analysis component 506, upon determining that an access limit has been exceeded, may instruct ACS 505 to secure the door 502 to the resource and/or instruct digital signage 504 and 503 to display appropriate messages.

Resource access limits 510 (e.g., parameters that define limits) may be derived from the analysis of a contagious infection and/or medical advice. For example, medical advice may state a minimum distance to be maintained between people during a pandemic. This minimum distance may be used to determine a maximum occupancy for a shared space, based on the dimensions of that space.

Resource access limits 510 may be dependent on the characteristics of the shared resource, such as the nature of the activity that people engage in while using the shared resource and the physical environment. For example, where access limits are set to reduce the risk of transmitting an infectious disease that is carried in respiratory droplets, a layout where people sit at benches facing a wall may present a lower risk of transmission than a layout where people sit at tables directly opposite from each other. Similarly, an activity that requires frequent movement within a shared space, and potentially crossing paths with other users, may present a higher risk of infection than an activity where people remain in a fixed location for the duration of the activity. High risk characteristics may require lower resource access limits, such as lower numbers of concurrent users and shorter time periods between cleanings. Low risk characteristics may make it acceptable to have higher resource access limits.

When a shared resource is a conference room and access is restricted because a capacity limit has been reached, the access restriction system 500 may instruct a room booking system to identify a second conference room that is available for the same time slot as the first conference room. The access restriction system 500 may instruct the room booking system to create a booking for the second conference room, and instruct digital signage to provide directions to the second conference room. The access restriction system 500 may further instruct the IT equipment in the first and second conference rooms to establish a conference call or video link between the two rooms. When a shared resource is a conference room and access is restricted due to required cleaning, maintenance, or other reason that prevents any access, then the access restriction system may instruct a room booking system to prevent people from booking the conference room. The access restriction system 500 may instruct a room booking system to cancel all bookings of the conference room for the remainder of the day, for a predicted period of closure, on a rolling basis with 15 minutes of advance warning, or some through some other method. When the access restriction is lifted, for example, after a cleaning operation is performed, the access restriction system 500 may instruct a room booking system to accept bookings of the affected room.

In some embodiments, doors that are secured through use of the ACS 505 to allow one-way use, so that people can vacate a restricted area but not gain access. One-way access on doors may also be used to establish a one-way system within an environment. For example, during a pandemic, regulations on the minimum distance to maintain between people may be enforced. If, for example, a corridor is too narrow to enable people to pass in opposite directions and maintain the minimum separation, then the doors at either end of the corridor may be set by the ACS 505 to allow one-way traffic, and ensure that people only travel along the corridor in one direction. In some embodiments, doors that are secured through use of the ACS 505 unlocking in exceptional circumstances, such as when a fire alarm is activated.

In some embodiments, sensors 501 are used to determine whether a resource is in use. When it is determined that access to a shared resource should be restricted, analysis component 506 may only command ACS 505 to secure the door 502 to the shared resource if there are no people currently using the shared resource.

Analysis component 506 maintains restrictions to a shared resource until a release condition is met. The release condition may be the completion of a cleaning or maintenance operation. For example, if the resource access limit is set to a maximum of 20 users between cleanings, access to the resource may be restricted after the twentieth user of the shared resource, and the counter reset after a cleaning operation has been performed. The cleaner, maintenance technician, or other worker may notify analysis component 506 through a smart phone app, website, or other method to indicate that the required operation has been completed. In some embodiments ACS 505 may notify analysis component 506 when the cleaner, maintenance technician, or other worker vacates the shared resource. In some embodiments, the release condition is the passage of a set amount of time from the start of the restricted access. In some embodiments, the release condition is the completion of an automated cycle, such as using a HVAC system to ventilate a room, spraying the room with a decontaminant, exposing surfaces to UV light, or some other process.

In some embodiments, analysis component 506 coordinates restricted access to one or more shared resources to improve the efficiency of regular, loosely scheduled cleaning or maintenance operations. For example, an office building may have multiple restrooms that are cleaned in a predefined order. However, the amount of time that it takes to clean each restroom may vary depending on the amount of work required. For this reason, the time at which each restroom is cleaned may vary from day to day. An individual may require exclusive access to a shared resource in order to perform the required work, either because of company policy, because the resource is not usable while the work is being performed, because the work makes the surrounding environment unsafe, because the presence of other people extends the amount of time required to complete the work, or for some other reason.

The system includes a digital record 508 of the planned schedule of restricted access to resources. The system also tracks the location of the individual who requires exclusive access to the resource 507. Analysis component 506 then combines these two sources of data to determine what information to display on digital signage 504 and/or 503.

The location of the person who requires exclusive access may be tracked through use of Bluetooth low energy beacons, a portable device used to check-in at specific locations, recording interaction with an access control system, or through some other location-tracking system. In some embodiments, where the people that require exclusive access to the resource are required to travel to the resource from another geographic location, outdoor tracking may be used. For example, the location of a third-party maintenance contractor may be tracked through the use of GPS, and used to determine an estimated time of arrival that is displayed on the digital signage.

In some embodiments, doors 502 may be unlocked automatically at the predicted time of arrival of the person who requires exclusive access. Doors 502 may be unlocked manually through use of an access reader module, such as 304 of FIG. 3, a mobile device, web interface, or similar application. When there is a sequence of resources that require restricted access, the application that is used to manually unlock doors may be simplified to present only the option to unlock the next door in the sequence.

In some embodiments, sensor information of the sensors 501 is used to secure the resource prior to the arrival of the person who requires exclusive access. A time window is defined prior to the estimated time of arrival. If sensor information of the sensors 501 indicates that the shared resource is not being used at any point within the defined time window, then analysis component 506, instructs ACS 505 to secure door 502. In the example of a restroom, the system may be configured such that the door is automatically locked if the restroom becomes vacant at any time within 10 minutes prior to the scheduled period of restricted access. Information about current usage may also affect which resources people are redirected to, with people not redirected to resources that are at or near maximum capacity.

In some embodiments, the access restriction system 500 maintains a historical record 509 of the length of time that resources remained restricted for. For example, the actual length of time that was required to clean each restroom. This information may be determined by tracking the person that requires exclusive access to the resources 507. The access restriction system 500 may use this information to improve the accuracy of predicted restrictions. Analysis component 506 may analyze the historical record 509 and/or a historical record 511 of resource usage reference to which operative performed the task, day of the week, time of day, building occupancy levels, weather, or other relevant data sources. The additional metadata enables a more accurate like-for-like comparison with the current context.

In some embodiments, the access restriction system includes an estimate of the amount of time that a person will require to use a resource. For example, a piece of lab equipment may require a fixed amount of time to complete analysis of a sample. When the nearest alternative resource is the next in the sequence to have restricted access, the access restriction system 500 determines if a person will have sufficient time to complete their task. If a person would not have sufficient time to complete their task, then they are re-directed to a third resource, where they will have sufficient time. Alternatively, when the nearest alternative resource is the next in the sequence to have restricted access, the digital signage that redirects the person may also indicate when the alternative resource is scheduled to close, and enable the person to determine if they have sufficient time.

In some embodiments, the access restriction system 500 tracks multiple schedules for multiple individuals that require exclusive access to resources. For example, multiple cleaning operatives that are allocated different sets of restrooms to clean.

In some embodiments, the analysis component 506 is connected to an ACS 505 to enforce the restricted access. Access to the resource may be restricted via door 502 in the lead up to the restricted time period. The access restriction may be independent of the display on the digital signage. For example, if a room contains lab equipment that is scheduled to undergo maintenance by a technician, the digital signage may display a notification of closure 30 minutes before the technician is predicted to arrive. However, the ACS may block access to anyone other than the technician 10 minutes before the technician is predicted to arrive. In some embodiments the door remains locked until the person that requires exclusive access has completed their task. Security personnel may still override door locks, as is typical in an ACS.

Determination that a task is complete may be made by tracking that the person who requires exclusive access has left the vicinity of the resource, through receipt of notification from the person that requires exclusive access that they have completed the task, or through some other method.

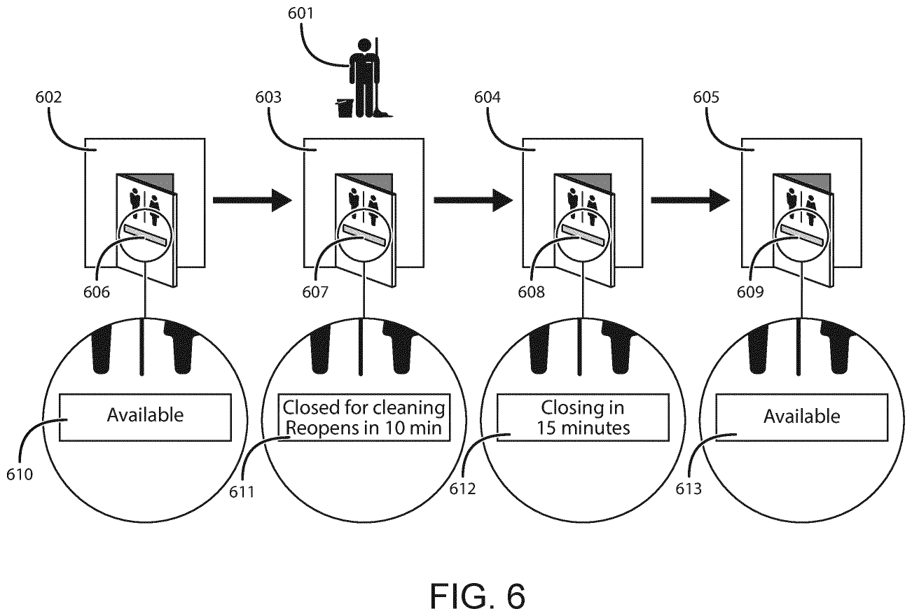

Referring now to FIG. 6, a sequence of messages displayed on digital signage is shown, according to some embodiments. Cleaning operative 601 is scheduled to clean a series of restrooms 602 to 605. Each restroom displays digital signage 606 to 609. The signage 606-609 may be used solely for the purpose of coordinating restricted use, or may also be used for other purposes, such as organizational communication. The signage 606-609 displays information related to restricted use. For example, if the cleaning operative 601 is currently cleaning restroom 603, digital signage 607 displays a message indicating that it is closed as shown in example 611. When a restroom is closed, the digital signage may also direct people to the nearest alternative restroom. For restrooms that have already been cleaned, e.g., restroom 602, or are scheduled to be cleaned beyond a set time limit, e.g., restroom 605, digital signage 606 and 609 may display messages 610 and 613 to indicate that the restrooms 602 and 605 are available. When a restroom is the next scheduled restroom to be cleaned, e.g., restroom 604, digital signage 608 displays a notice that it will be closing soon, e.g., example 612.

In some embodiments, the access restriction system 500 calculates an estimate for how long access to a resource will be restricted. This information may be used to display the remaining time for closure on the digital signage 611. If there is a sequence of closures, this information may also be used to predict when the next resource should be restricted, and to update the associated digital signage 612. In the example of cleaning restrooms, the aim is to minimize both the length of time that the cleaning operative has to wait outside of the restroom, and the length of time that the restroom is closed prior to being cleaned.

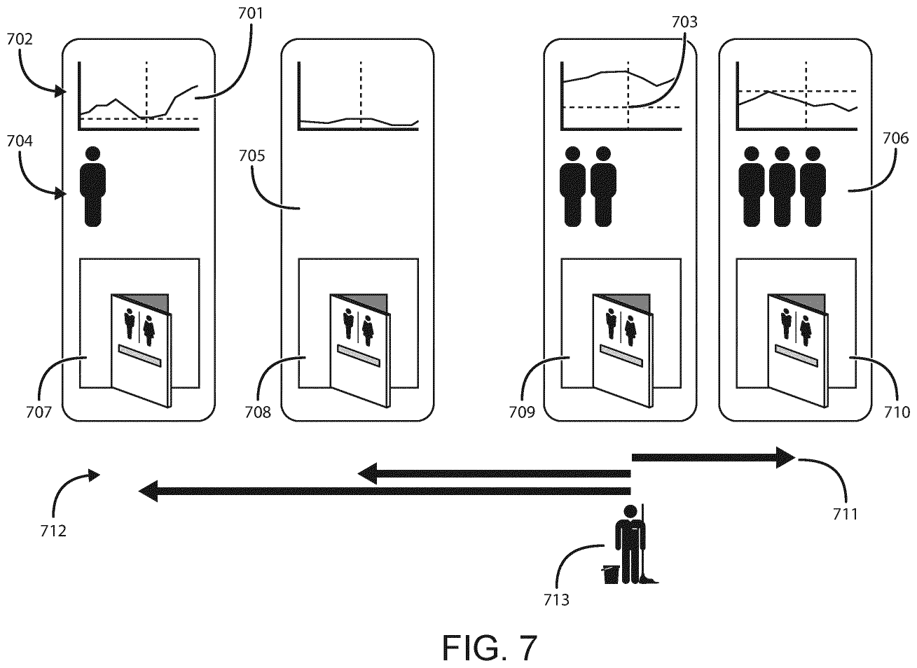

Referring now to FIG. 7, a diagram representing a cleaning schedule optimization method is shown, according to some embodiments. In some embodiments, where there are multiple resources that require restricted access for limited time periods, a schedule optimizer (e.g., the analysis component 506) determines which resource should be attended to next. The schedule optimizer may be part of analysis component 506 of FIG. 5. When cleaning operative 713 is cleaning restroom 709, the analysis component may determine which of the yet to be cleaned restrooms 707, 708, and 710 should be attended to next.

In determining the next shared resource to attend to, the schedule optimizer may evaluate the skills and characteristics of the person that requires exclusive access to the resource. For example, maintenance technicians may have specific skills that are required to service particular equipment, or to resolve a reported fault.

In determining the next shared resource to attend to, the schedule optimizer may evaluate the distance 712 between cleaner 713 and restrooms 707, 708, and 710. Shorter travel distances 711 may be prioritized. The schedule optimizer may take into account the requirement to visit all resources in the schedule, and aim to minimize lengthy journeys to return to resources that have been skipped.

In determining the next shared resource to attend to, the schedule optimizer may evaluate current usage of shared resource 704. For example, the system may determine that selecting a restroom that is further away 708, but vacant 705, is preferable to selecting the nearest restroom 710 that has a high occupancy 706.

In determining the next shared resource to attend to, the schedule optimizer may evaluate historical usage of the shared resource 702. In FIG. 7, the line graph represents the historical record of use, and the dashed lines are the intersection of the equivalent current time (x axis) and the current occupancy (y axis). A shared resource that is currently in use may be allocated a higher preference for selection, if the current usage is below the typical usage, e.g. 703. A shared resource may also be allocated a higher preference for selection if it is determined that the current period is likely to be followed by a higher period of use, e.g. 701.

In determining the next shared resource to attend to, the schedule optimizer may evaluate amount of time that the resource has to be restricted for. This may be considered in relation to the record of historical use, to determine if the person that requires exclusive access can complete their task before a period of peak use.

Schedule optimizer may use a scoring system, where each factor contributes to a score that is assigned to each resource. For example, a high level of current occupancy may contribute a high score to a resource, while a low level of current occupancy may contribute a low score to a resource. The system may then select the resource with lowest combined score.

The data recorded by the system may be used to generate reports. A “bottleneck” report may identify points within a sequence of resource closures where there are excessive wait periods. A “schedule improvement” report may compare completion times before and after schedule changes, to determine if changes led to an improvement. A “load balancing” report may identify if redirection rules are creating an imbalance in the use of alternative resources, and whether the redirection rules should be adjusted. A “recurring issues” report may identify resources that require significantly longer time than anticipated to service. For example, if maintenance on a piece of equipment regularly takes longer than expected, then this may indicate a fault in the equipment or that it is being used incorrectly.

In some embodiments, people that require use of a shared resource access information about availability through an application on a mobile device or desktop computer. Before a person departs on their journey to a shared resource, they may select the type of resource from a set of icons or a list displayed in the application. The application may then display information about current closures, upcoming closures, recommended alternatives, recommended routes to available shared resources, and/or other information. The application may track the application user's current location in order to determine the closest available resource and optimal routes to the available resources. In some embodiments, an application on a mobile device tracks the application user's location as they move through a space. The application may use historical information and direction of travel to determine that the user is moving towards a shared resource that is unavailable, notify the user through auditory, vibrational, and/or on-screen alert about the unavailability, and then direct the user to an alternative shared resource.

When directing people to alternative shared resources, either through digital signage 504, an application on a mobile device, or some other method, the system 500 may evaluate potential risks associated with each route. Potential risks may include, but are not limited to, passing through areas where large groups of people gather and the risk of contracting an infectious disease is higher, passing through or near construction sites, walking outside during periods of inclement weather, and/or using stairs when the user has impinging medical issues. The lowest risk route may be selected by the system 500, or there may by an upper limit of acceptable risk, where any routes that exceed this limit of acceptable risk are disregarded. The risks in the environment may be represented internally within the system 500 and/or presented to a user as a heat map stored by the system 500. A risk scale may be defined where one end of the scale represents the lowest risk and the opposite end of the scale represents the highest risk. Risks within an environment are assigned a value on this scale by the system 500. A risk may have an extended area of effect, where the risk value is highest at the location of the risk and reduces as the distance from the risk increases. When represented visually, the risk scale may be mapped to a color gradient.

The access restriction system 500 may implement restricted access to shared resources based on parameters not directly tied to the shared resource itself. Example parameters may include overall building occupancy, national or regional pandemic threat level, time of day, and national holidays. Rules may be created by the system 500 to restrict access to shared resources when a specific parameter is higher or lower than a predetermined threshold. For example, if building occupancy is lower than a predetermined threshold, then some restrooms may be closed to reduce the number of rooms that must be cleaned. If building occupancy is higher than a predetermined threshold, then a one-way system for corridors may be implemented by the system 500 through configuring one-way access control on doorways.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method of mitigating risk of infection for users of a shared space of a building, the method comprising:
receiving, by one or more processing circuits, risk data indicative of at least one of behavior of the users relating to the shared space or a user risk relating to a risk of one or more of the users contracting or spreading a disease;
determining, by the one or more processing circuits, an accessibility limit for the shared space based on the risk data, the accessibility limit comprising at least one of an occupancy limit for the shared space or a timeframe during which the shared space is prohibited from occupancy; and
generating, by the one or more processing circuits, an indicator of the accessibility limit for the shared space, the indicator providing an indication to the users of at least one of the occupancy limit or the timeframe during which the shared space is prohibited from occupancy.

2. The method of claim 1, further comprising:
generating, by the one or more processing circuits, social distancing scores for the users of the shared space; and
determining, by the one or more processing circuits, the accessibility limit for the shared space comprises determining the accessibility limit using the social distancing scores.

3. The method of claim 1, further comprising:
transmitting, by the one or more processing circuits responsive to determining the accessibility limit for the shared space, at least one of control signals or data to an access control device configured to cause the access control device to control access to the shared space.

4. The method of claim 1, further comprising scheduling cleaning of the shared space based on the accessibility limit.

5. The method of claim 1, wherein the shared space is a conference room, and wherein the accessibility limit comprises at least one of:
prohibiting access to the conference room;
limiting access to the conference room during one or more time periods; or
limiting booking of the conference room within a booking system.

6. The method of claim 1, further comprising:
receiving, by the one or more processing circuits, a heat map of the shared space, wherein determining the accessibility limit for the shared space comprises determining the accessibility limit using the heat map.

7. The method of claim 1, further comprising:
determining, by the one or more processing circuits, an alternative shared space;
determining, by the one or more processing circuits, a plurality of possible routes to the alternative shared space;
receiving, by the one or more processing circuits, a heat map relating to the plurality of possible routes;
determining, by the one or more processing circuits, using the heat map, risks relating to contact with other users for the plurality of possible routes;
selecting, by the one or more processing circuits, a first route from among the plurality of possible routes based on the risks; and
providing, by the one or more processing circuits, directions to the alternative shared space using the first route.

8. The method of claim 1, further comprising:
transmitting, by the one or more processing circuits, the indicator to a user device, the indicator comprising data configured to cause the user device to provide an indication of the accessibility limit for the shared space.

9. The method of claim 1, further comprising:
providing the indicator via a digital sign proximate to an entrance to the shared space.

10. The method of claim 9, wherein the shared space is a bathroom;
wherein the digital sign is provided proximate to a door to the bathroom;
wherein the indicator indicates the bathroom is closed.

11. The method of claim 1, further comprising:
providing, by the one or more processing circuits responsive to determining the accessibility limit to the shared space, an indication of an alternative shared space to use instead of the shared space.

12. The method of claim 11, further comprising:
providing, by the one or more processing circuits, directions to the alternative shared space by:
determining a plurality of potential routes to the alternative shared space;
determining risks relating to contact with other users for the plurality of potential routes;
selecting a first route from among the plurality of potential routes based on the risks; and
providing directions to the alternative shared space using the first route.

13. The method of claim 1, further comprising:
receiving, by the one or more processing circuits, historical occupancy data indicating occupancy of the shared space at one or more previous times; and
determining, by the one or more processing circuits, the accessibility limit for the shared space by determining the accessibility limit using the historical occupancy data.

14. The method of claim 13, further comprising:
determining, by the one or more processing circuits, the accessibility limit using the historical occupancy data by:
determining, using the historical occupancy data, a timeframe during which occupancy has been above a threshold level; and
determining the accessibility limit for the shared space during the timeframe.

15. A building system of a building comprising one or more memory devices storing instructions thereon that, when executed by one or more processors, cause the one or more processors to:
receive risk data indicative of at least one of behavior of users relating to a shared space or a user risk relating to a risk of one or more of the users contracting or spreading a disease;
determine an accessibility limit for the shared space based on the risk data, the accessibility limit comprising at least one of an occupancy limit for the shared space or a timeframe during which the shared space is prohibited from occupancy; and
generate an indicator of the accessibility limit for the shared space, the indicator providing an indication to the users of at least one of the occupancy limit or the timeframe during which the shared space is prohibited from occupancy.

16. The building system of claim 15, wherein the instructions cause the one or more processors to:
generate social distancing scores for the users of the shared space, wherein determining the accessibility limit for the shared space comprises determining the accessibility limit using the social distancing scores.

17. The building system of claim 15, wherein the instructions cause the one or more processors to:
transmit, responsive to determining the accessibility limit for the shared space, at least one of control signals or data to an access control device configured to cause the access control device to control access to the shared space.

18. The building system of claim 15, wherein the instructions cause the one or more processors to:
schedule cleaning of the shared space based on the accessibility limit.

19. A method of improving efficiency of scheduled maintenance or cleaning activities, the method comprising:
identifying, by one or more processing circuits, a worker who will perform a maintenance or cleaning activity;
associating, by the one or more processing circuits, a shared resource with the maintenance or cleaning activity;
identifying, by the one or more processing circuits, a time at which the maintenance or cleaning activity will start;
performing, by the one or more processing circuits, at least one of:
providing a notification to one or more users in advance of the time at which the maintenance or cleaning activity will start and that the shared resource will become unavailable; or
prohibiting use of the shared resource in advance of the time.

20. The method of claim 19, wherein identifying, by the one or more processing circuits, the time at which the maintenance or cleaning activity will start comprises:
determining a distance between the worker and the shared resource;
determining rate of progress of the worker towards the shared resource; and
calculating an estimated time when the worker will arrive at said shared resource.
